(19) United States
(12) Patent Application Publication
(10) Pub. No.: US 2026/0238086 A1
(43) Pub. Date: Aug. 13, 2026

(54) AIR RELIEF FEATURE IN AN ELECTRIC MOTOR LAMINATION STACK

(71) Applicant: Schaeffler Technologies AG & Co. KG, Herzogenaurach (DE)

(72) Inventors: Jacob Sheradin, North Canton, OH (US); Zachary Gnabah, Massillon, OH (US)

(21) Appl. No.: 19/049,452

(22) Filed: Feb. 10, 2025

(51) Int. Cl. H02K 9/02; H02K 1/16

(52) U.S. Cl. CPC H02K 9/02; H02K 1/16

(57) ABSTRACT

Two or more laminations are introduced at intervals along the axial length of the stator to form air relief passages. The air relief passages may not meaningfully impact motor performance. The air relief passages enable radial and axial injection molding for longer stator cores. Plastic may be injected from the inner diameter of the stator to the outer diameter, or vice-versa. Plastic may also be injected axially. The air relief passages may evacuate trapped air when the plastic is injected. The radial injection molding in combination with the air relief passage may enable increasing the axial length of stators.

### TECHNICAL FIELD

The present disclosure generally relates to dynamo-electric machines, and more particularly, to slot insulation between windings and stator cores.

### BACKGROUND

Stators may include slots liner between slots of a stator core and windings. Current methods for lining the slots involve either inserting sleeves, typically paper, or injecting plastic around a form. The plastic injection is beneficial to seal the slot from the inner diameter of the stator and enable direct cooling of the windings.

The slot liners may be formed by plastic injection molding or transfer molding. The plastic of the slot liners may be injected plastics axially, such that the plastic is injected from one end of the stator, through the entire length of the slot, and out the other side. A consequence of injecting the plastic axially is that the plastic becomes increasingly difficult to flow along the axial length as the stator increases in length. Achieving sufficient flow along the length of the slot may be problematic when using axial injection molding and transfer molding with increasing axial lengths. Some stator designs are longer than what may be manufactured with injection molding or transfer molding. Therefore, it would be advantageous to provide a device, system, and method that cures the shortcomings described above.

### SUMMARY

An air-relief plate is described, in accordance with one or more embodiments of the present disclosure. In some embodiments, the air-relief plate includes: a plurality of teeth, wherein the plurality of teeth define a plurality of winding slots, wherein the plurality of winding slots are defined axially through the air-relief plate, wherein the plurality of winding slots are circumferentially disposed between and radially aligned with the plurality of teeth, wherein the plurality of teeth and the plurality of winding slots are defined in a polar array about a center axis of the air-relief plate, and a ring, wherein the plurality of teeth and the plurality of winding slots extend radially inwards from the ring, wherein the air-relief plate is an annulus shape with an inner diameter and an outer diameter, wherein the inner diameter is defined by the plurality of teeth and the plurality of winding slots, wherein the outer diameter is defined by the ring; wherein the ring defines a plurality of air-relief slots and a plurality of joints in a plurality of linear arrays extending radially between respective of the plurality of winding slots and the outer diameter.

In some aspects, the plurality of air-relief slots are configured to define a plurality of air-relief passages with at least one additional air-relief plate which is axially aligned with and adjacent to the air-relief plate, wherein each of the plurality of winding slots are fluidically coupled with a respective of the plurality of air-relief passages, wherein the plurality of air-relief passages are radially defined between the plurality of winding slots and the outer diameter.

In some aspects, the plurality of joints are radially disposed between respective of the plurality of air-relief slots in the plurality of linear arrays.

In some aspects, the plurality of linear arrays include a plurality of slot-first linear arrays, wherein the plurality of slot-first linear arrays include one of the plurality of air-relief slots disposed adjacent to the plurality of winding slots, followed by respective of the plurality of joints and the plurality of air-relief slots.

In some aspects, the plurality of linear arrays include a plurality of joint-first linear arrays, wherein the plurality of joint-first linear arrays include one of the plurality of joints disposed adjacent to the plurality of winding slots, followed by respective of the plurality of air-relief slots and the plurality of joints.

In some aspects, the plurality of linear arrays include a plurality of slot-first linear arrays and a plurality of joint-first linear arrays, wherein the air-relief plate includes a polar array of the plurality of slot-first linear arrays and the plurality of joint-first linear arrays repeating in sequence about the center axis of the air-relief plate.

In some aspects each of the plurality of linear arrays include a matching number of the plurality of air-relief slots and the plurality of joints.

In some aspects, each of the plurality of linear arrays do not include a matching number of the plurality of air-relief slots and the plurality of joints.

In some aspects, the air-relief plate is made of a ferromagnetic material.

A stator core is described, in accordance with one or more embodiments of the present disclosure. In some embodiments, the stator core includes: at least two air-relief plates, wherein the at least two air-relief plates are axially aligned with and adjacent to each other, wherein the at least two air-relief plates include: a plurality of teeth, wherein the plurality of teeth define a plurality of winding slots, wherein the plurality of winding slots are defined axially through the at least two air-relief plates, wherein the plurality of winding slots are circumferentially disposed between and radially aligned with the plurality of teeth, wherein the plurality of teeth and the plurality of winding slots are defined in a polar array about a center axis of the at least two air-relief plates, and a ring, wherein the plurality of teeth and the plurality of winding slots extend radially inwards from the ring, wherein the at least two air-relief plates are an annulus shape with an inner diameter and an outer diameter, wherein the inner diameter is defined by the plurality of teeth and the plurality of winding slots, wherein the outer diameter is defined by the ring; wherein the ring defines a plurality of air-relief slots and a plurality of joints in a plurality of linear arrays extending radially between respective of the plurality of winding slots and the outer diameter; wherein the plurality of air-relief slots are configured to define a plurality of air-relief passages with the at least two air-relief plates, wherein each of the plurality of winding slots are fluidically coupled with a respective of the plurality of air-relief passages, wherein the plurality of air-relief passages are radially defined between the plurality of winding slots and the outer diameter.

In some aspects, the plurality of air-relief slots of the at least two air-relief plates are circumferentially aligned and partially radially overlapping with axially adjacent of the plurality of air-relief slots within the plurality of linear arrays.

In some aspects, the plurality of linear arrays include a plurality of slot-first linear arrays and a plurality of joint-first linear arrays, wherein the at least two air-relief plates includes a polar array of the plurality of slot-first linear arrays and the plurality of joint-first linear arrays repeating in sequence about the center axis of the at least two air-relief plates.

In some aspects, the plurality of slot-first linear arrays and the plurality of joint-first linear arrays of a first of the at least two air-relief plates are circumferentially aligned with respective of the plurality of joint-first linear arrays and the plurality of slot-first linear arrays of a second of the at least two air-relief plates.

In some aspects, the stator core includes at least four air-relief plates, wherein the stator core includes at least two of the at least four air-relief plates with slot-first linear arrays and at least two of the at least four air-relief plates with joint-first linear arrays for each of the plurality of air-relief passages.

In some aspects, the stator core includes multiple sets of air-relief plates defining the plurality of air-relief passages along an axial length of the stator core.

In some aspects, a first of the at least two air-relief plates includes only a polar array of a plurality of slot-first linear arrays and a second of the at least two air-relief plates includes only a polar array of a plurality of joint-first linear arrays.

In some aspects, the at least two air-relief plates are electrically insulated from each other.

A stator is described, in accordance with one or more embodiments of the present disclosure. In some embodiments, the stator includes: at least two air-relief plates, wherein the at least two air-relief plates are axially aligned with and adjacent to each other, wherein the at least two air-relief plates include: a plurality of teeth, wherein the plurality of teeth define a plurality of winding slots, wherein the plurality of winding slots are defined axially through the at least two air-relief plates, wherein the plurality of winding slots are circumferentially disposed between and radially aligned with the plurality of teeth, wherein the plurality of teeth and the plurality of winding slots are defined in a polar array about a center axis of the at least two air-relief plates, and a ring, wherein the plurality of teeth and the plurality of winding slots extend radially inwards from the ring, wherein the at least two air-relief plates are an annulus shape with an inner diameter and an outer diameter, wherein the inner diameter is defined by the plurality of teeth and the plurality of winding slots, wherein the outer diameter is defined by the ring; wherein the ring defines a plurality of air-relief slots and a plurality of joints in a plurality of linear arrays extending radially between respective of the plurality of winding slots and the outer diameter; wherein the plurality of air-relief slots are configured to define a plurality of air-relief passages with the at least two air-relief plates, wherein each of the plurality of winding slots are fluidically coupled with a respective of the plurality of air-relief passages, wherein the plurality of air-relief passages are radially defined between the plurality of winding slots and the outer diameter; a plurality of slot insulation; and a plurality of windings, wherein the plurality of slot insulation and the plurality of windings are disposed in the plurality of winding slots, wherein the plurality of slot insulation electrically insulates the stator core from the plurality of windings.

In some aspects, the plurality of slot insulation fills at least a portion of the plurality of air-relief passages.

In some aspects, the plurality of slot insulation are radially injected into the plurality of winding slots, wherein the plurality of air-relief passages evacuate air when the plurality of slot insulation are radially injected.

It is to be understood that both the foregoing general description and the following detailed description are exemplary and explanatory only and are not necessarily restrictive of the present disclosure. The accompanying drawings, which are incorporated in and constitute a part of the specification, illustrate subject matter of the disclosure. Together, the description and drawings serve to explain the principles of the disclosure.

### BRIEF DESCRIPTION OF THE DRAWINGS

The numerous advantages of the disclosure may be better understood by those skilled in the art by reference to the accompanying figures in which:

FIG. 1A depicts a perspective view of an air-relief plate, in accordance with one or more embodiments of the present disclosure.

FIG. 1B depicts a partial perspective view of the air-relief plate, in accordance with one or more embodiments of the present disclosure.

FIG. 1C depicts a top view of the air-relief plate, in accordance with one or more embodiments of the present disclosure.

FIG. 2A depicts a perspective view of a stator core with the air-relief plates and non-air-relief plates, in accordance with one or more embodiments of the present disclosure.

FIG. 2B depicts a perspective view of the stator core hiding the non-air-relief plates disposed above the air-relief plates, in accordance with one or more embodiments of the present disclosure.

FIG. 2C depicts a perspective view of the stator core hiding one of the air-relief plates and the non-air-relief plates disposed above the air-relief plates, in accordance with one or more embodiments of the present disclosure.

FIG. 2D depicts a cross-section perspective view of the stator core illustrating an air-relief passage defined by the air-relief plates, in accordance with one or more embodiments of the present disclosure.

FIG. 2E depicts a partial cross-section perspective view of the stator core illustrating the air-relief passage defined by the air-relief plates, in accordance with one or more embodiments of the present disclosure.

FIG. 2F depicts a partial cross-section side view of the stator core illustrating the air-relief passage defined by the air-relief plates, in accordance with one or more embodiments of the present disclosure.

FIG. 3A depicts a top view of a stator including the stator core, in accordance with one or more embodiments of the present disclosure.

FIG. 3B depicts a partial cross-section side view of the stator illustrating a slot insulation filling the air-relief passage, in accordance with one or more embodiments of the present disclosure.

FIG. 4A depicts a perspective view of the stator core with the air-relief plates, in accordance with one or more embodiments of the present disclosure.

FIG. 4B depicts a partial cross-section side view of the stator core illustrating the air-relief passage defined by the air-relief plates, in accordance with one or more embodiments of the present disclosure.

FIG. 5 depicts a perspective view of the stator core with multiple sets of the air-relief plates, in accordance with one or more embodiments of the present disclosure.

FIG. 6A depicts a perspective view of the stator core with the air-relief plates, in accordance with one or more embodiments of the present disclosure.

FIG. 6B depicts a perspective view of the stator core hiding the non-air-relief plates disposed above the air-relief plates, in accordance with one or more embodiments of the present disclosure.

FIG. 6C depicts a perspective view of the stator core hiding one of the air-relief plates and the non-air-relief plates disposed above the air-relief plates, in accordance with one or more embodiments of the present disclosure.

FIG. 7 depicts a partial cross-section side view of the stator core illustrating the air-relief passage defined by the air-relief plates, in accordance with one or more embodiments of the present disclosure.

FIG. 8 depicts a flow diagram of a method, in accordance with one or more embodiments of the present disclosure.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of components. Therefore, specific structural and functional details disclosed herein are not to be interpreted as limiting, but merely as a representative basis for teaching one skilled in the art to variously employ the embodiments. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

Embodiments of the present disclosure are directed to an air relief feature in an electric motor lamination stack. Two or more laminations are introduced at intervals along the axial length of the stator to form air relief passages. The air relief passages may not meaningfully impact motor performance. The air relief passages enable radial and axial injection molding for longer stator cores. Plastic may be injected from the inner diameter of the stator to the outer diameter, or vice-versa. Plastic may also be injected axially. The air relief passages may evacuate trapped air when the plastic is injected. The radial injection molding in combination with the air relief passage may enable increasing the axial length of stators.

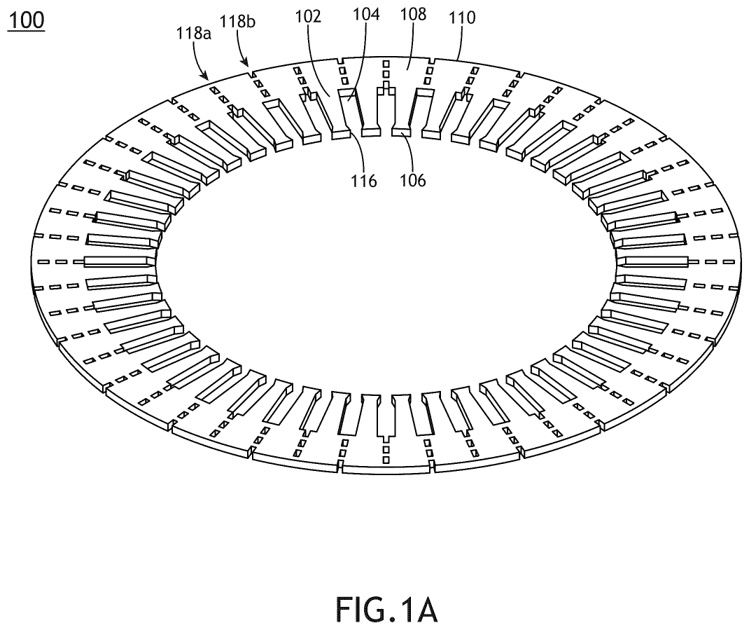

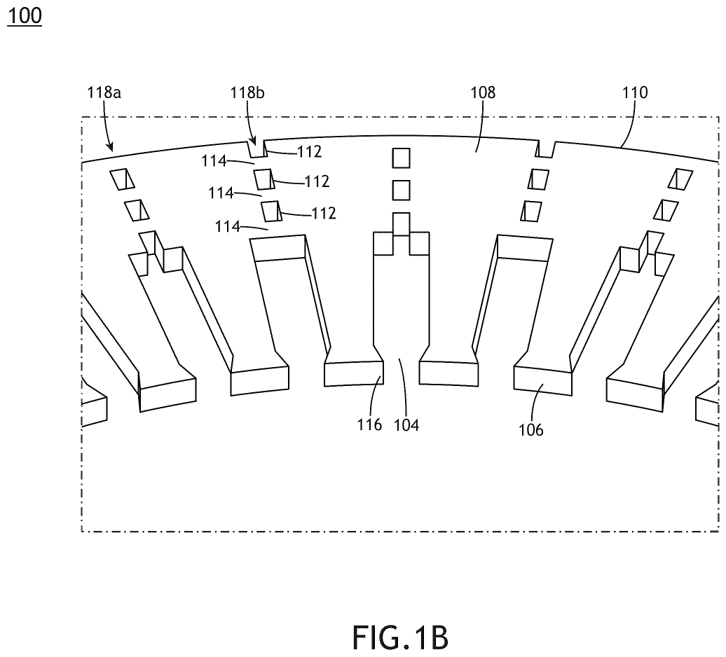

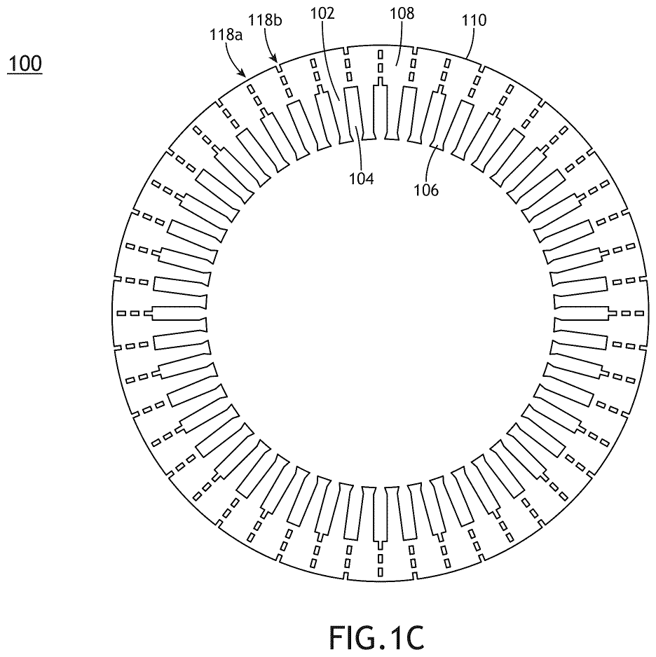

FIGS. 1A-1C depict an air-relief plate 100, in accordance with one or more embodiments of the present disclosure. The air-relief plate 100 may include teeth 102, winding slots 104, an inner diameter 106, a ring 108, an outer diameter 110, air-relief slots 112, and/or joints 114.

The air-relief plate 100 may be an annulus shape with the inner diameter 106 and the outer diameter 110. The inner diameter 106 may be a centered-through hole of the air-relief plate 100. The inner diameter 106 may also be referred to as a center bore, a rotor hole, or the like. The inner diameter 106 may be defined by the teeth 102 and the winding slots 104 (e.g., the inner surfaces of the teeth 102). The outer diameter 110 may be defined by the ring 108 (e.g., the outer surface of the ring 108). The inner diameter 106 may be defined axially through the air-relief plate 100. The inner diameter 106 and outer diameter 110 may be concentric. The inner diameter 106 and outer diameter 110 may be concentric to a center axis of the air-relief plate 100. The inner diameter 106 may be smaller than the outer diameter 110.

The teeth 102 may define the winding slots 104. The winding slots 104 may be defined axially through the air-relief plate 100. The winding slots 104 may circumferentially disposed between and radially aligned with the teeth 102.

The teeth 102 and the winding slots 104 may include a select shape. For example, the winding slots 104 may be rectangular-shaped and the teeth 102 may taper radially inwards, although this is not intended as a limitation of the present disclosure. The rectangular-shape may be beneficial for achieving a high packing density of windings within the winding slots 104. It is further contemplated that the teeth 102 may be rectangular-shaped and the winding slots 104 may taper radially inwards.

The teeth 102 may include tooth tips 116. The tooth tips 116 may define the inner diameter 106. The tooth tips 116 may extend circumferentially outwards into the winding slots 104. The tooth tips 116 may restrict access to the winding slots 104 (e.g., for preventing windings from translating radially inwards through to the inner diameter 106).

The teeth 102, the winding slots 104, the air-relief slots 112, and/or the joints 114 may be defined in a polar array about a center axis of the air-relief plate 100. Thus, the teeth 102, the winding slots 104, the air-relief slots 112, and/or the joints 114 may be circumferentially distributed about the center axis.

The air-relief plate 100 may include a matching number of the teeth 102 and the winding slots 104. The air-relief plate 100 may include any number of the teeth 102 and the winding slots 104. For example, the number of the winding slots 104 in the air-relief plate 100 may be 24, 36, 54, 72, 96, or the like, although this is not intended to be limiting. The angular spacing between adjacent of the teeth 102 and/or between the adjacent of the winding slots 104 may be based on the number of the teeth 102 and the winding slots 104.

The ring 108 may be disposed radially outwards of the teeth 102 and the winding slots 104. The teeth 102 and the winding slots 104 may extend radially inwards from the ring 108.

The ring 108 may define the air-relief slots 112 and the joints 114. The air-relief slots 112 and the joints 114 may include a select shape. For example, the air-relief slots 112 and the joints 114 may be rectangular shaped, although this is not intended as a limitation of the present disclosure.

The air-relief slots 112 and the joints 114 may be defined in linear arrays 118 extending radially between respective of the winding slots 104 and the outer diameter 110. The air-relief slots 112 of the air-relief plate 100 may not form one continuous channel from the winding slots 104 and the outer diameter 110. Respective of the joints 114 may be radially disposed between respective of the air-relief slots 112 in the linear arrays 118 to prevent the ring 108 from being broken into segments. Each of the winding slots 104 may be disposed adjacent to a respective of the linear arrays 118.

The air-relief slots 112 and the joints 114 may repeat in a sequence along the linear arrays 118. The sequence may include any number of the air-relief slots 112 and the joints 114. The air-relief plate 100 may include any number of the air-relief slots 112 and the joints 114 in each of the respective of the linear arrays 118. For example, the air-relief plate 100 is depicted with three of the air-relief slots 112 and three of the joints 114 in each of the respective of the linear arrays 118, although this is not intended as a limitation of the present disclosure. It is contemplated that the linear arrays 118 may include at least one of the air-relief slots 112 and at least one of the joints 114. However, providing additional of the joints 114 may be beneficial to improve a strength of the ring 108 of the air-relief plate 100.

One of the air-relief slots 112 or the joints 114 may be disposed adjacent to the winding slots 104. For example, the air-relief slots 112 and the joints 114 may be arranged in a slot-first linear arrays 118a and/or a joint-first linear arrays 118b. The slot-first linear arrays 118a may include one of the air-relief slots 112 disposed adjacent to the winding slots 104, followed by respective of the joints 114 and the air-relief slots 112. Similarly, the joint-first linear arrays 118b may include one of the joints 114 disposed adjacent to the winding slots 104, followed by respective of the air-relief slots 112 and the joints 114.

The linear arrays 118 may include a matching number of the air-relief slots 112 and the joints 114. For example, the slot-first linear arrays 118a with the matching number of the air-relief slots 112 and the joints 114 may end with one of the joints 114 disposed adjacent to the outer diameter 110. By way of another example, the joint-first linear arrays 118b with the matching number of the air-relief slots 112 and the joints 114 may end with one of the air-relief slots 112 disposed adjacent to the outer diameter 110.

The air-relief plate 100 may include a polar array of the slot-first linear arrays 118a and the joint-first linear arrays 118b. For example, the slot-first linear arrays 118a and the joint-first linear arrays 118b may repeat in sequence about the center axis of the air-relief plate 100.

The air-relief plate 100 may be made of a ferromagnetic material. The ferromagnetic material may be a metal or metal alloy thereof. The ferromagnetic metal may be ferrous or non-ferrous. For example, the ferromagnetic material may include, but is not limited to, electrical steel (e.g., steel having a silicon content), iron, nickel, cobalt, ferrite, and alloys thereof. The air-relief plate 100 may be fabricated from a sheet metal blank via a stamping process.

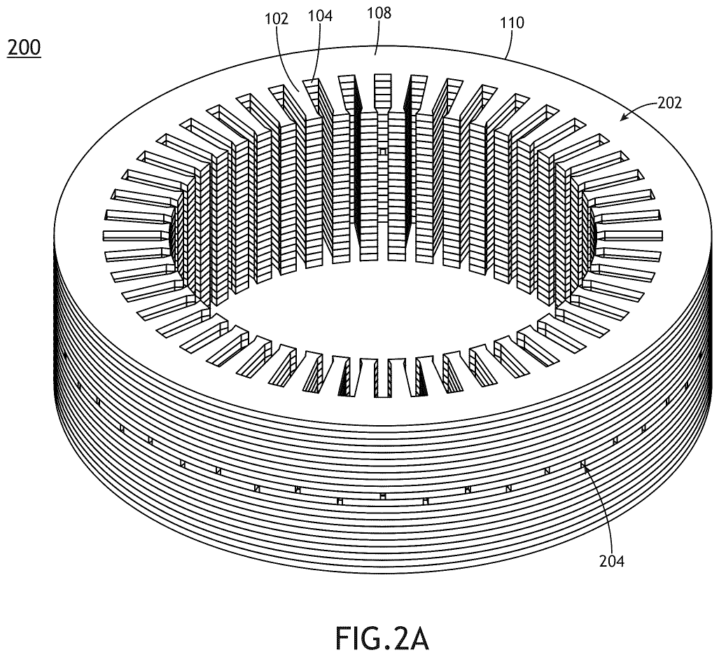

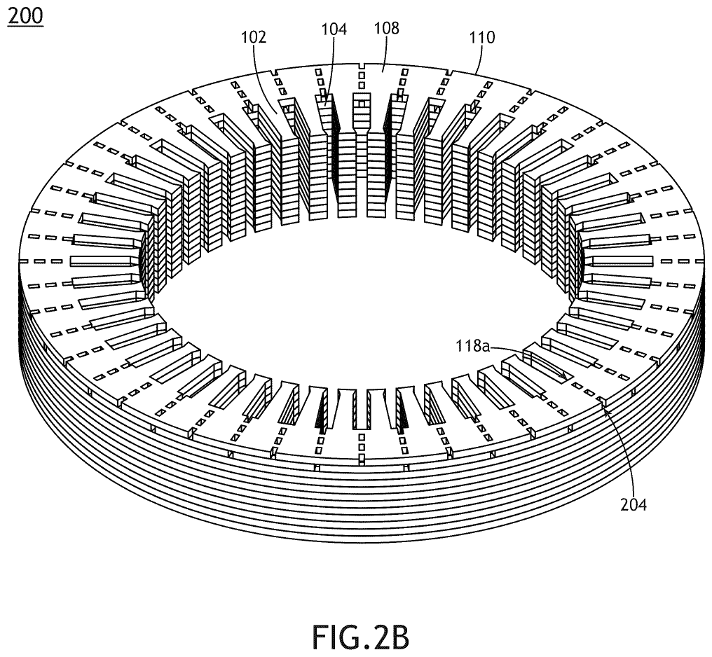

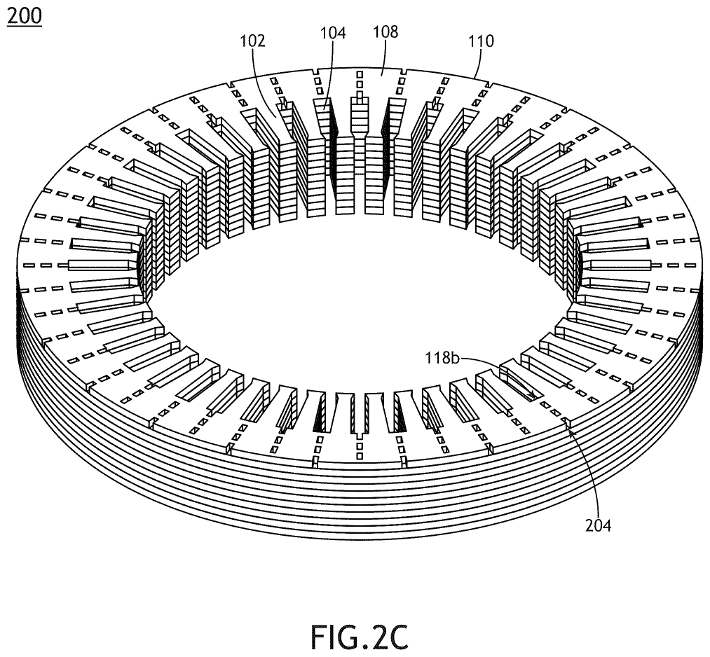

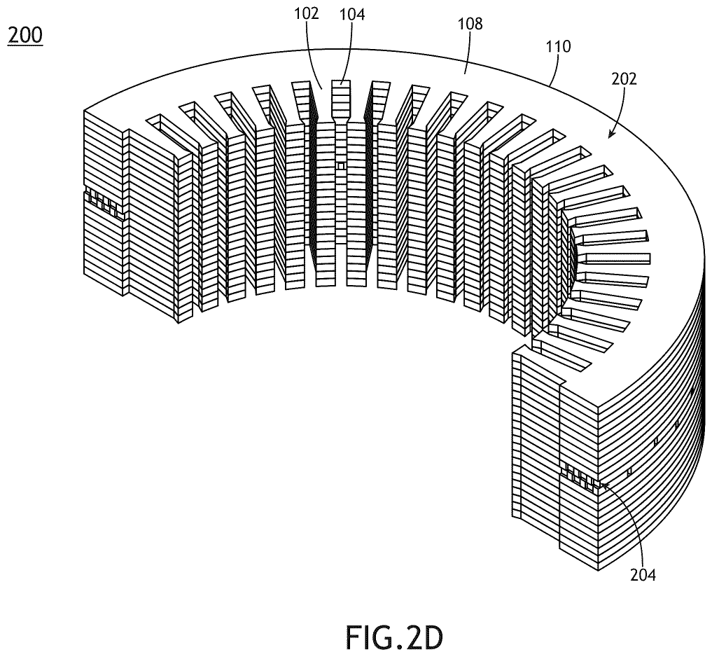

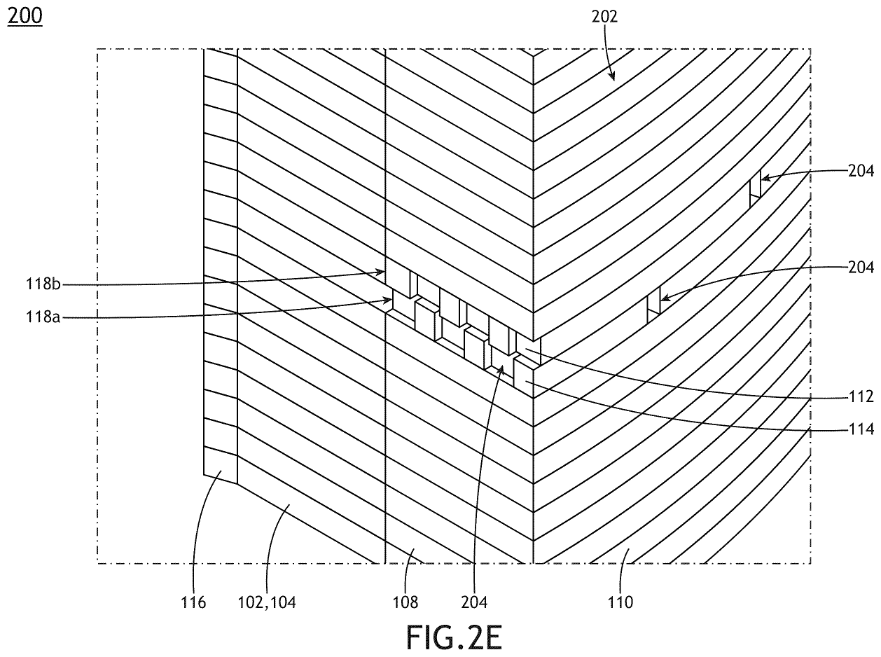

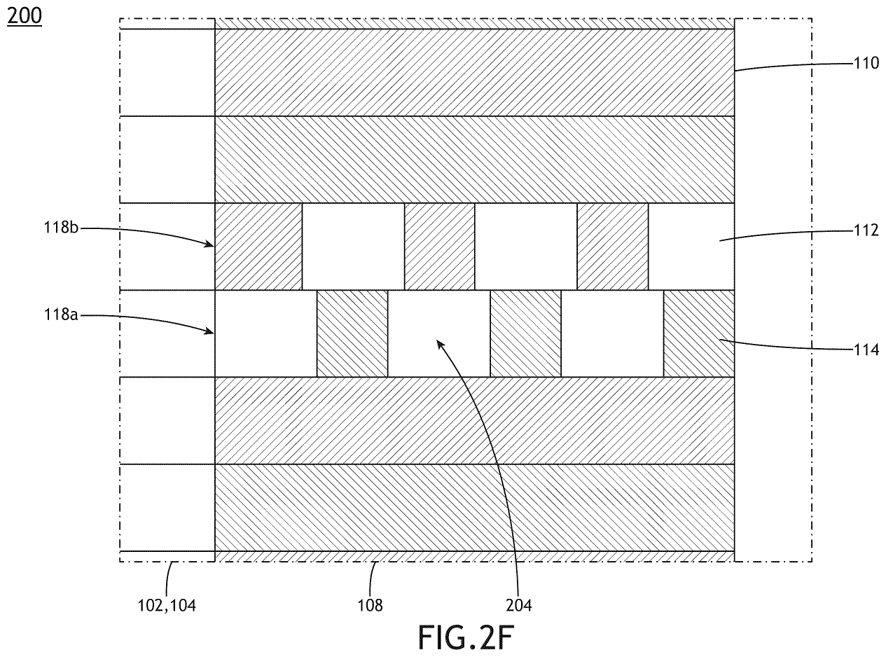

FIGS. 2A-2F depict a stator core 200, in accordance with one or more embodiments of the present disclosure. The stator core 200 may be a magnetic core with a high magnetic permeability. The stator core 200 may include the air-relief plates 100 and/or non-air-relief plates 202. The air-relief plates 100 and the non-air-relief plates 202 may be axially stacked and laminated together to form the stator core 200. The air-relief plates 100 and/or the non-air-relief plates 202 may be laminated together using a process, such as, but not limited to, welding, sintering, clinching, adhering, or the like.

The air-relief plates 100 and the non-air-relief plates 202 may include the teeth 102, the winding slots 104, the inner diameter 106, the ring 108, and/or the outer diameter 110. The teeth 102, the winding slots 104, the inner diameter 106, the ring 108, and/or the outer diameter 110 of the air-relief plates 100 and the non-air-relief plates 202 may be aligned. For example, the inner diameter 106 of the air-relief plates 100 and the non-air-relief plates 202 may be concentric such that the inner diameter 106 is defined through the axial length of the stator core 200. By way of another example, the winding slots 104 may be circumferentially aligned such that the winding slots 104 are defined through the axial length of the stator core 200.

The air-relief slots 112 may define air-relief passages 204. Two or more of the air-relief plates 100 which are axially aligned with and adjacent to each other which include the air-relief slots 112 may define air-relief passages 204. Thus, the air-relief slots 112 of one of the air-relief plates 100 may be configured to define the air-relief passages 204 with at least one additional of the air-relief plates 100 which is axially aligned with and adjacent to the air-relief plate 100. The stator core 200 may include at least one of the air-relief plates 100 with the slot-first linear arrays 118a and at least one of the air-relief plates 100 with the joint-first linear arrays 118b for each of the air-relief passages 204. The slot-first linear arrays 118a and the joint-first linear arrays 118b may be circumferentially aligned to define the air-relief passages 204. Axially adjacent of the air-relief plates 100 may include the slot-first linear arrays 118a and the joint-first linear arrays 118b which are circumferentially aligned. The circumferential alignment of the slot-first linear arrays 118a and the joint-first linear arrays 118b and the form the air-relief passages 204.

The air-relief passages 204 may also be referred to as air-relief features or channels. Each of the winding slots 104 may be fluidically coupled with a respective of the air-relief passages 204. The air-relief passages 204 may be radially defined between the winding slots 104 and the outer diameter 110. Air may be relieved from the winding slots 104 to the outer diameter 110 via the air-relief passages 204. The air-relief passages 204 may be serpentine (e.g., a square wave). The air-relief slots 112 of the air-relief plates 100 may be circumferentially aligned and partially radially overlapping with axially adjacent of the air-relief slots 112 within the linear arrays 118. Portions of the air-relief slots 112 may also be radially separated from axially adjacent of the air-relief slots 112 by the joints 114. The amount of radial overlap may be controlled based on the radial width of the air-relief slots 112 and the joints 114.

In an example, the air-relief plates 100 may include the polar array of the slot-first linear arrays 118a and the joint-first linear arrays 118b, with a first of the air-relief plates 100 clocked relative to a second of the air-relief plates 100 by an angle corresponding to the angle between adjacent of the winding slots 104. Thus, the slot-first linear arrays 118a and the joint-first linear arrays 118b of the first of the air-relief plates 100 may be circumferentially aligned with respective of the joint-first linear arrays 118b and the slot-first linear arrays 118a of the second of the air-relief plates 100.

The air-relief plates 100 may include the air-relief slots 112 and/or the joints 114, while the non-air-relief plates 202 may not include the air-relief slots 112 and/or the joints 114. The discussion of the air-relief plates 100 is incorporated herein by reference as to the non-air-relief plates 202, with the exception that the non-air-relief plates 202 do not include the air-relief slots 112 and/or the joints 114.

The stator core 200 may include any number of the air-relief plates 100 and/or the non-air-relief plates 202. For example, the stator core 200 may include tens or hundreds of the air-relief plates 100 and/or the non-air-relief plates 202. An axial length of the stator core 200 may be based on the axial length of the air-relief plates 100 and/or the non-air-relief plates 202 and the number of the air-relief plates 100 and/or the non-air-relief plates 202.

Each of the air-relief plates 100 and/or the non-air-relief plates 202 may be electrically insulated from each other. The air-relief plate 100 and/or the non-air-relief plates 202 may be coated with insulating layers (not depicted) to electrically insulate the air-relief plates 100 and/or the non-air-relief plates 202 from one another. Electrically insulating the air-relief plates 100 and/or the non-air-relief plates 202 may be beneficial to reduce eddy currents between the air-relief plates 100 and/or the non-air-relief plates 202.

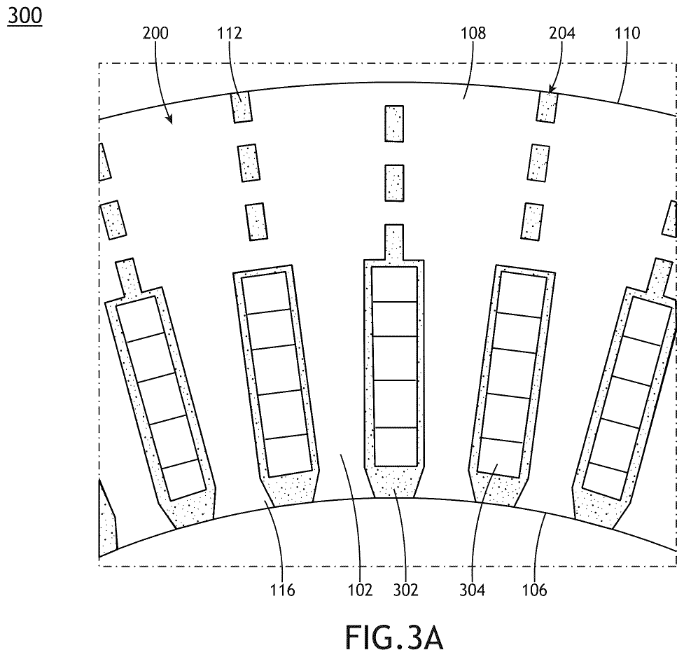

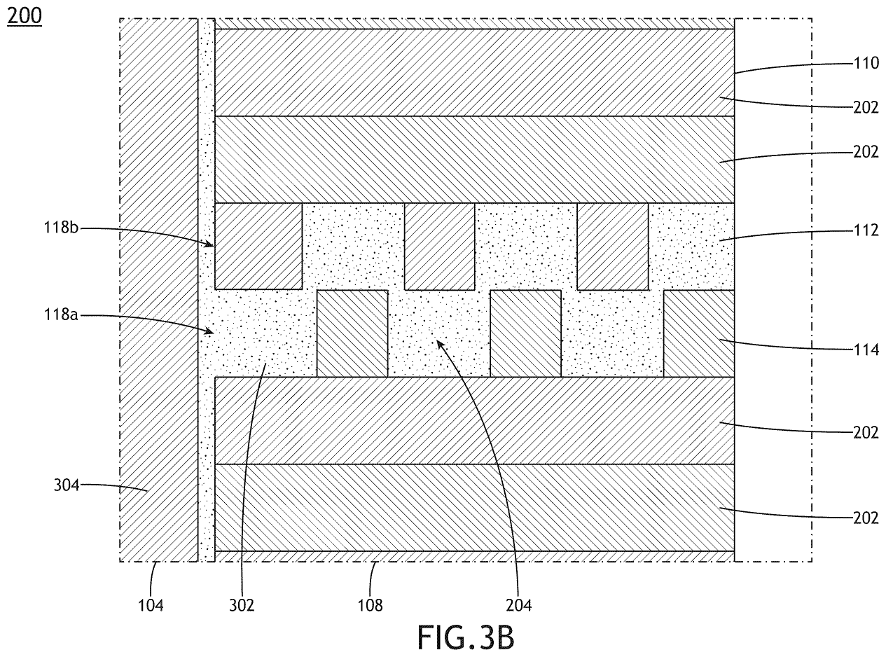

FIGS. 3A-3B depict a stator 300, in accordance with one or more embodiments of the present disclosure. The stator 300 may include the stator core 200, slot insulation 302, and/or windings 304.

The slot insulation 302 and the windings 304 may be disposed in the winding slots 104. The slot insulation 302 and the windings 304 may extend along the axial length of the winding slots 104. The slot insulation 302 may be disposed between the windings 304 and both the teeth 102 and the ring 108. The slot insulation 302 may conform to surfaces of the teeth 102 and the ring 108 around the windings 304. The slot insulation 302 may also fill the region of the winding slots 104 between the tooth tips 116. The stator core 200 may mechanically support the windings 304 via the slot insulation 302.

The windings 304 may include any suitable windings. For example, the windings 304 may be hairpin windings, wave windings, or the like. The hairpin windings may be inserted axially into the winding slots 104. The windings 304 may be a distributed winding, where each of the windings 304 may be distributed across two or more of the winding slots 104. The windings 304 may be a single-layer winding, a double-layer winding or the like. The windings 304 may be wound around the teeth 102 of the air-relief plates 100 and non-air-relief plates 202. The windings 304 may be configured to generate a magnetic field. The stator core 200 may confine the magnetic field generated by the windings 304 inside the inner diameter 106. The windings 304 may define the poles of the stator 300. The stator 300 may include one or more of the windings 304 per pole-group.

The slot insulation 302 may electrically insulate the stator core 200 from the windings 304. For example, the slot insulation 302 may be made from an electrical insulator, such as, but not limited to, injection-molded plastic. The slot insulation 302 may be injected directly into the winding slots 104. The slot insulation 302 may or may not fill the air-relief passages 204 (e.g., the air-relief slots 112). For example, the slot insulation 302 may fill at least a portion of or the entirety of the air-relief passages 204. The air-relief passages 204 may provide a flow path through which air and the slot insulation 302 may flow when injecting the slot insulation 302 into the winding slots 104.

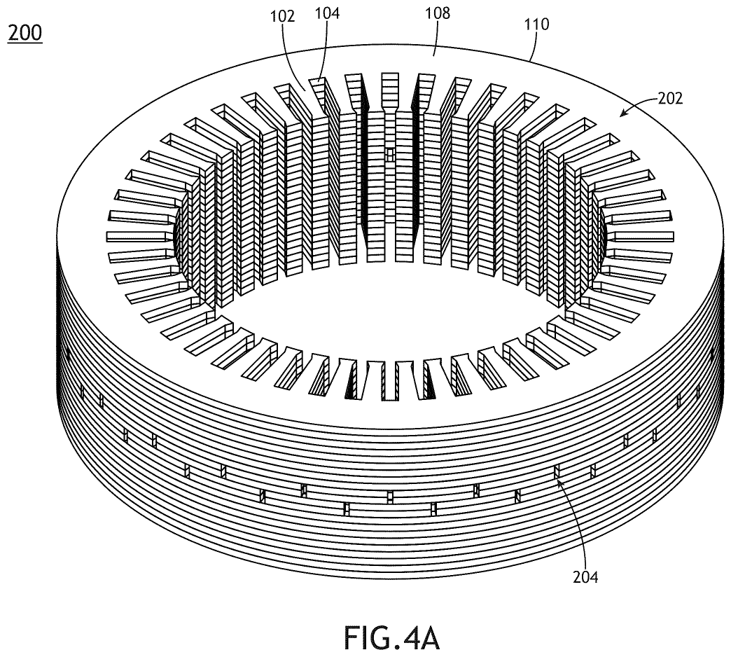

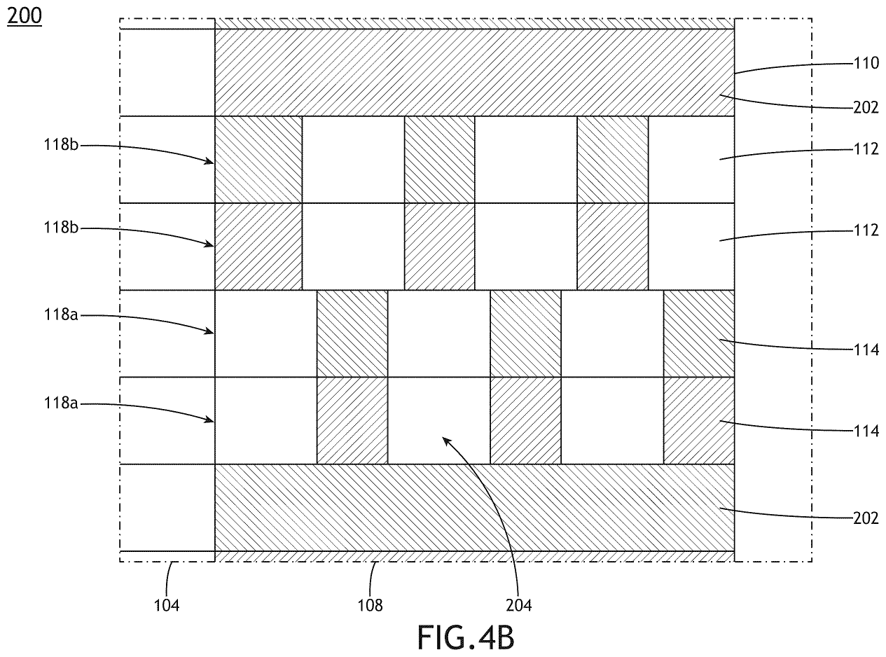

FIGS. 4A-4B depict the stator core 200, in accordance with one or more embodiments of the present disclosure. In embodiments, the stator core 200 at least two of the air-relief plates 100 with the slot-first linear arrays 118a and at least two of the air-relief plates 100 with the joint-first linear arrays 118b for each of the air-relief passages 204 (e.g., a total of four, six, eight, or more). In this regard, the axial length of the air-relief passages 204 may be increased by increasing the number of the air-relief plates 100 defining the air-relief passages 204.

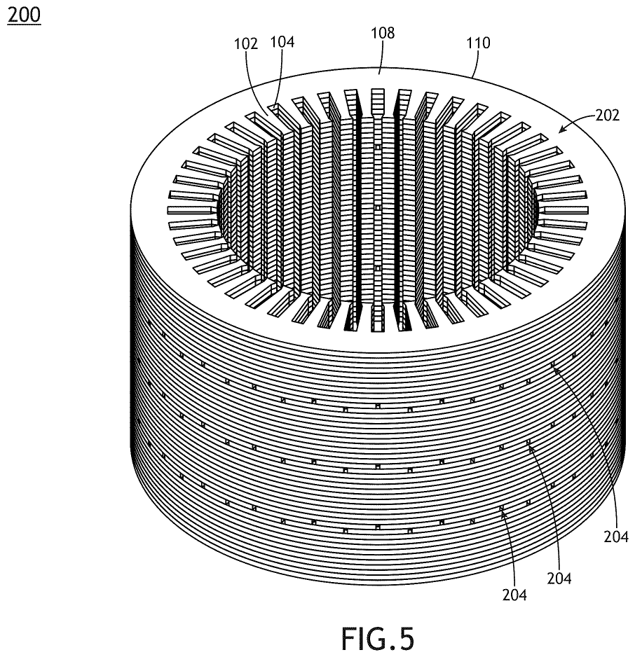

FIG. 5 depicts the stator core 200, in accordance with one or more embodiments of the present disclosure. In embodiments, the stator core 200 may include multiple sets of the air-relief plates 100 defining the air-relief passages 204 along the axial length of the stator core 200 with the non-air-relief plates 202 disposed therebetween. In the example, depicted, the stator core 200 includes three sets of the air-relief plates 100 defining the air-relief passages 204, although this is not intended to be limiting. Each of the sets may include two or more of the air-relief plates 100 (e.g., two, four, six, eight, or more).

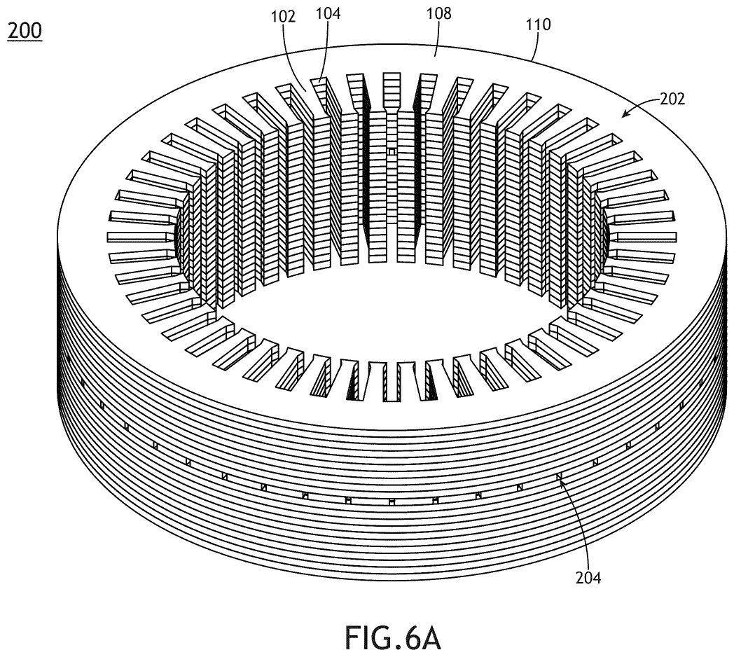

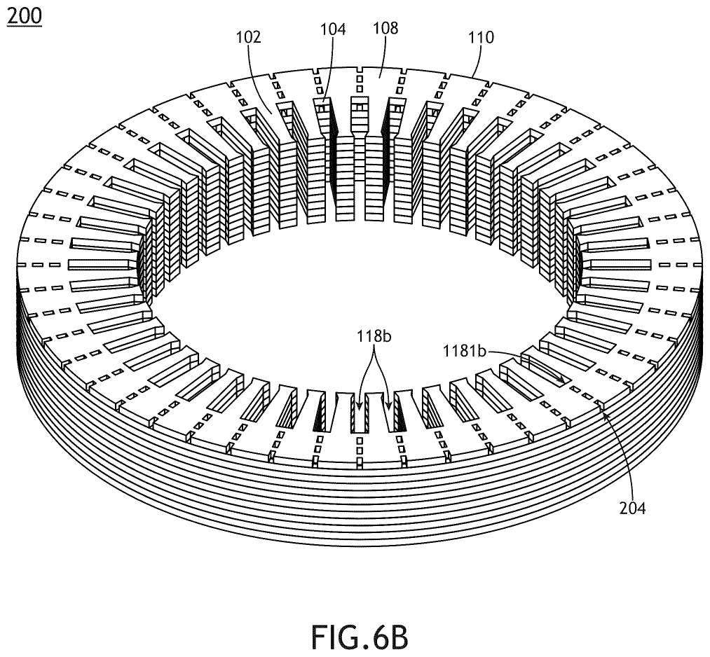

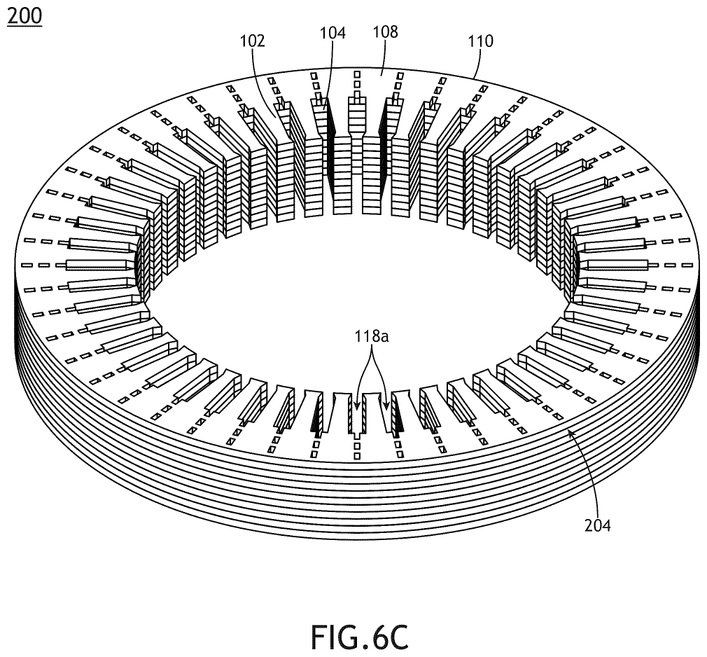

FIGS. 6A-6C depict the stator core 200, in accordance with one or more embodiments of the present disclosure. Although the stator core 200 is described as including the air-relief plates 100 with the polar array of the slot-first linear arrays 118a and the joint-first linear arrays 118b, with a first of the air-relief plates 100 clocked relative to a second of the air-relief plates 100 by an angle corresponding to the angle between adjacent of the winding slots 104, this is not intended as a limitation of the present disclosure. In embodiments, a first of the air-relief plates 100 includes only the polar array of the slot-first linear arrays 118a and a second of the air-relief plates 100 includes only the polar array of the joint-first linear arrays 118b.

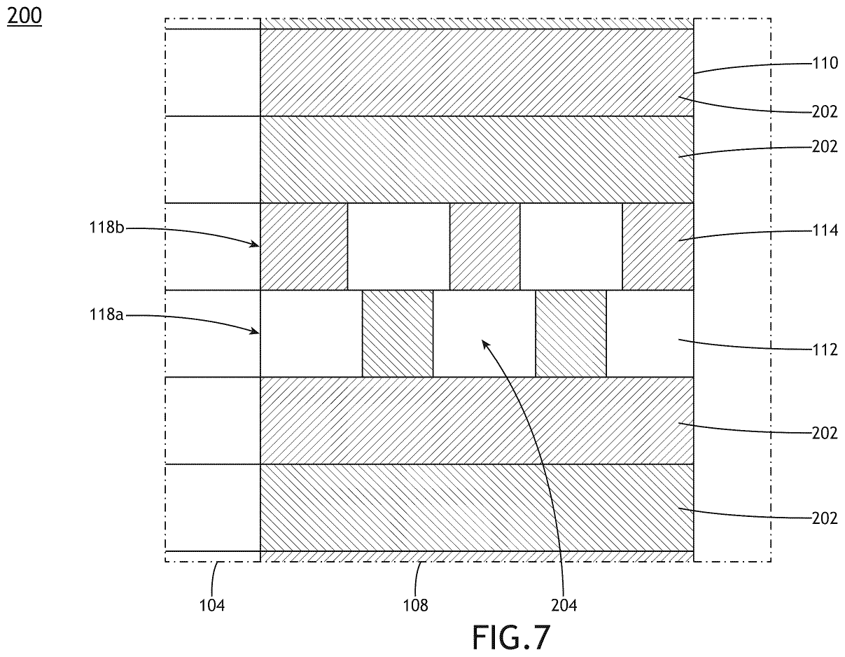

FIG. 7 depicts the stator core 200, in accordance with one or more embodiments of the present disclosure. In embodiments, the linear arrays 118 do not include the matching number of the air-relief slots 112 and the joints 114. For example, the slot-first linear arrays 118a may include one more of the air-relief slots 112 than the joints 114 and may end with one of the air-relief slots 112 disposed adjacent to the outer diameter 110. By way of another example, the joint-first linear arrays 118b may include one more of the joints 114 than the air-relief slots 112 and may end with one of the joints 114 disposed adjacent to the outer diameter 110. The air-relief plate 100 including the polar array of the slot-first linear arrays 118a and the joint-first linear arrays 118b may be beneficial to reduce a tooling used to stamp the air-relief slots 112 and the joints 114, at the expense of having to clock the air-relief plate 100.

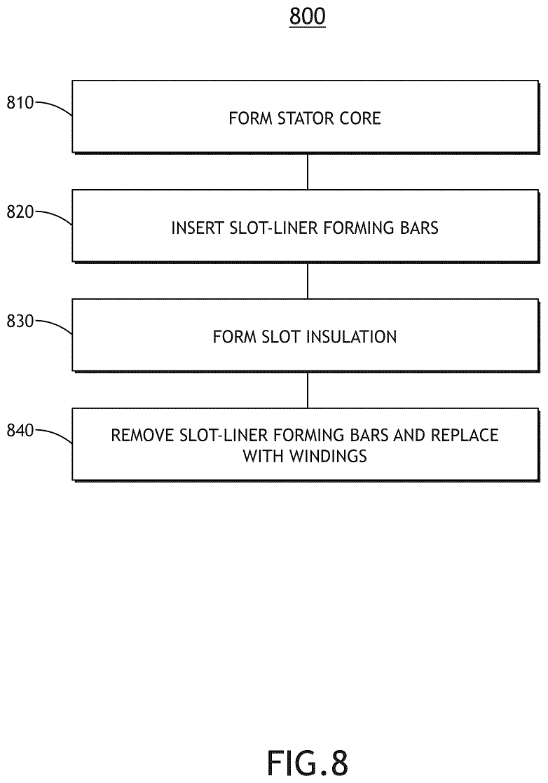

FIG. 8 depicts a flow diagram of a method 800, in accordance with one or more embodiments of the present disclosure. The method 800 may be a method of forming the stator 300. The embodiments and enabling technologies described previously herein in the context of the stator 300 should be interpreted to extend to method 800. It is further noted, however, that the method is not limited to the architecture of the stator 300.

In a step 810, a stator core 200 may be formed by axially stacking and laminating together the air-relief plates 100 and the non-air-relief plates 202. One or more of the air-relief plates 100 and/or the non-air-relief plates 202 may be rotated to even out the flatness of the stator core 200. Sub-stacks may be rotated and assembled to form the stator core 200. The axial length of these sub-stacks is convenient such that the addition of the air-relief plates 100 could be included having no negative impact on manufacturability. A first of the air-relief plates 100 may also be rotated to clock the first of the air-relief plates 100 relative to a second of the air-relief plates 100 by the angle corresponding to the angle between adjacent of the winding slots 104.

In a step 820, slot-liner forming bars (not depicted) may be inserted into the winding slots 104. The slot-liner forming bars may occupy the space to be occupied by the windings 304.

In a step 830, plastic may be injected into the winding slots 104 and at least a portion of the air-relief passages 204 around the slot-liner forming bars and cooled to form the slot insulation 302. The plastic may be injected via any suitable technique, such as injection-molding or transfer-molding. The plastic may be radially injected. For example, the plastic may be injected into the winding slots 104 from the inner diameter 106 and flows around the forming bar into the air-relief passages 204. Alternatively or additionally, the plastic may be axially injected from either axial end. The air-relief passages 204 may enable radially injecting plastic. Radially injecting the slot insulation 302 into the winding slots 104 in combination with the addition of the air-relief passages 204 may be beneficial to increase an axial length of the stator core 200 while extending the slot insulation 302 along the axial length of the winding slots 104. Without the air-relief passages 204, the plastic may compress the air within the winding slots 104 thereby incompletely filling the slot insulation 302 against the teeth 102 and/or the ring 108, leaving an air pocket or void.

In a step 840, the slot-liner forming bars may be removed and replaced with the windings 304.

It is further contemplated that each of the embodiments of the method described above may include any other step(s) of any other method(s) described herein. In addition, each of the embodiments of the method described above may be performed by any of the systems described herein.

Referring generally again to the figures. The removal of material from the air-relief plates 100 to define the air-relief passages 204 may reduce the magnetic confinement provided by the stator core 200. It is desirable to have as little removal of the metal for electromagnetic reasons while provided sufficiently large of the air-relief passages 204 to allow flow of the slot insulation 302. Most of the stator core 200 may be the non-air-relief plates 202 to minimize the electromagnetic impact. Thus, the size of the air-relief slots 112, the number of the air-relief slots 112 and the joints 114 in each of the linear arrays 118, the number of the air-relief plates 100 defining each of the air-relief passages 204, and/or the number of the air-relief passages 204 along the axial length of the stator core 200 may be balanced separately or in combination between achieving sufficient flow of the slot insulation 302 against the magnetic confinement provided by the stator core 200.

The stator 300 may be a stator for a dynamo-electric machine such as an electric motor or an electric generator. The electric motor may be a modular hybrid transmission (MHT), a hybrid module, an electric axle, or the like. The electric motor may include a rotor (not depicted). The stator 300 may be disposed radially outwards of and axially aligned with the rotor. The stator 300 may be configured to generate the magnetic field causing the rotor to generate torque.

One skilled in the art will recognize that the herein described components operations, devices, objects, and the discussion accompanying them are used as examples for the sake of conceptual clarity and that various configuration modifications are contemplated. Consequently, as used herein, the specific exemplars set forth and the accompanying discussion are intended to be representative of their more general classes. In general, use of any specific exemplar is intended to be representative of its class, and the non-inclusion of specific components, operations, devices, and objects should not be taken as limiting.

As used herein, the term “axial” and derivatives thereof, such as “axially,” shall be understood to refer to a direction along the axis configured to rotate in operation of the apparatus described herein. The term “coaxial” shall be understood to refer to rotatable about a common axis. Further, the term “radial” and derivatives thereof, such as “radially,” shall be understood in relation to the axis of the axis. For example, “radially outward” refers to further away from the axis, while “radially inward” refers to nearer to the axis. The term “circumference” or derivatives thereof, such as “circumferentially”, may also be defined in reference to the center axis.

As used herein, directional terms such as “top,” “bottom,” “over,” “under,” “upper,” “upward,” “lower,” “down,” and “downward” are intended to provide relative positions for purposes of description, and are not intended to designate an absolute frame of reference. Various modifications to the described embodiments will be apparent to those with skill in the art, and the general principles defined herein may be applied to other embodiments

With respect to the use of substantially any plural and/or singular terms herein, those having skill in the art can translate from the plural to the singular and/or from the singular to the plural as is appropriate to the context and/or application. The various singular/plural permutations are not expressly set forth herein for sake of clarity.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the disclosure that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. As such, to the extent any embodiments are described as less desirable than other embodiments or prior art implementations with respect to one or more characteristics, these embodiments are not outside the scope of the disclosure and can be desirable for particular applications.

### LIST OF REFERENCE NUMBERS

100 air-relief plates
102 teeth
104 winding slots
106 inner diameter
108 ring
110 outer diameter
112 air-relief slots
114 joints
116 tooth tips
118 linear arrays
118a slot-first linear arrays
118b joint-first linear arrays
200 stator core
202 non-air-relief plates
204 air-relief passages
300 stator
302 slot insulation
304 windings
800 method
810 step
820 step
830 step
840 step

What is claimed:

1. An air-relief plate of a stator core, the air-relief plate comprising:
a plurality of teeth, wherein the plurality of teeth define a plurality of winding slots, wherein the plurality of winding slots are defined axially through the air-relief plate, wherein the plurality of winding slots are circumferentially disposed between and radially aligned with the plurality of teeth, wherein the plurality of teeth and the plurality of winding slots are defined in a polar array about a center axis of the air-relief plate, and
a ring, wherein the plurality of teeth and the plurality of winding slots extend radially inwards from the ring, wherein the air-relief plate is an annulus shape with an inner diameter and an outer diameter, wherein the inner diameter is defined by the plurality of teeth and the plurality of winding slots, wherein the outer diameter is defined by the ring;
wherein the ring defines a plurality of air-relief slots and a plurality of joints in a plurality of linear arrays extending radially between respective of the plurality of winding slots and the outer diameter.

2. The air-relief plate of claim 1, wherein the plurality of air-relief slots are configured to define a plurality of air-relief passages with at least one additional air-relief plate which is axially aligned with and adjacent to the air-relief plate, wherein each of the plurality of winding slots are fluidically coupled with a respective of the plurality of air-relief passages, wherein the plurality of air-relief passages are radially defined between the plurality of winding slots and the outer diameter.

3. The air-relief plate of claim 1, wherein the plurality of joints are radially disposed between respective of the plurality of air-relief slots in the plurality of linear arrays.

4. The air-relief plate of claim 1, wherein the plurality of linear arrays comprise a plurality of slot-first linear arrays, wherein the plurality of slot-first linear arrays comprise one of the plurality of air-relief slots disposed adjacent to the plurality of winding slots, followed by respective of the plurality of joints and the plurality of air-relief slots.

5. The air-relief plate of claim 1, wherein the plurality of linear arrays comprise a plurality of joint-first linear arrays, wherein the plurality of joint-first linear arrays comprise one of the plurality of joints disposed adjacent to the plurality of winding slots, followed by respective of the plurality of air-relief slots and the plurality of joints.

6. The air-relief plate of claim 1, wherein the plurality of linear arrays comprise a plurality of slot-first linear arrays and a plurality of joint-first linear arrays, wherein the air-relief plate comprises a polar array of the plurality of slot-first linear arrays and the plurality of joint-first linear arrays repeating in sequence about the center axis of the air-relief plate.

7. The air-relief plate of claim 1, wherein each of the plurality of linear arrays comprise a matching number of the plurality of air-relief slots and the plurality of joints.

8. The air-relief plate of claim 1, wherein each of the plurality of linear arrays do not comprise a matching number of the plurality of air-relief slots and the plurality of joints.

9. The air-relief plate of claim 1, wherein the air-relief plate is made of a ferromagnetic material.

10. A stator core comprising:
at least two air-relief plates, wherein the at least two air-relief plates are axially aligned with and adjacent to each other, wherein the at least two air-relief plates comprise:
a plurality of teeth, wherein the plurality of teeth define a plurality of winding slots, wherein the plurality of winding slots are defined axially through the at least two air-relief plates, wherein the plurality of winding slots are circumferentially disposed between and radially aligned with the plurality of teeth, wherein the plurality of teeth and the plurality of winding slots are defined in a polar array about a center axis of the at least two air-relief plates, and
a ring, wherein the plurality of teeth and the plurality of winding slots extend radially inwards from the ring, wherein the at least two air-relief plates are an annulus shape with an inner diameter and an outer diameter, wherein the inner diameter is defined by the plurality of teeth and the plurality of winding slots, wherein the outer diameter is defined by the ring;
wherein the ring defines a plurality of air-relief slots and a plurality of joints in a plurality of linear arrays extending radially between respective of the plurality of winding slots and the outer diameter;
wherein the plurality of air-relief slots are configured to define a plurality of air-relief passages with the at least two air-relief plates, wherein each of the plurality of winding slots are fluidically coupled with a respective of the plurality of air-relief passages, wherein the plurality of air-relief passages are radially defined between the plurality of winding slots and the outer diameter.

11. The stator core of claim 10, wherein the plurality of air-relief slots of the at least two air-relief plates are circumferentially aligned and partially radially overlapping with axially adjacent of the plurality of air-relief slots within the plurality of linear arrays.

12. The stator core of claim 10, wherein the plurality of linear arrays comprise a plurality of slot-first linear arrays and a plurality of joint-first linear arrays, wherein the at least two air-relief plates comprises a polar array of the plurality of slot-first linear arrays and the plurality of joint-first linear arrays repeating in sequence about the center axis of the at least two air-relief plates.

13. The stator core of claim 12, wherein the plurality of slot-first linear arrays and the plurality of joint-first linear arrays of a first of the at least two air-relief plates are circumferentially aligned with respective of the plurality of joint-first linear arrays and the plurality of slot-first linear arrays of a second of the at least two air-relief plates.

14. The stator core of claim 10, wherein the stator core comprises at least four air-relief plates, wherein the stator core comprises at least two of the at least four air-relief plates with slot-first linear arrays and at least two of the at least four air-relief plates with joint-first linear arrays for each of the plurality of air-relief passages.

15. The stator core of claim 10, comprising multiple sets of air-relief plates defining the plurality of air-relief passages along an axial length of the stator core.

16. The stator core of claim 10, wherein a first of the at least two air-relief plates includes only a polar array of a plurality of slot-first linear arrays and a second of the at least two air-relief plates includes only a polar array of a plurality of joint-first linear arrays.

17. The stator core of claim 10, wherein the at least two air-relief plates are electrically insulated from each other.

18. A stator comprising:
a stator core comprising:
at least two air-relief plates, wherein the at least two air-relief plates are axially aligned with and adjacent to each other, wherein the at least two air-relief plates comprise:
a plurality of teeth, wherein the plurality of teeth define a plurality of winding slots, wherein the plurality of winding slots are defined axially through the at least two air-relief plates, wherein the plurality of winding slots are circumferentially disposed between and radially aligned with the plurality of teeth, wherein the plurality of teeth and the plurality of winding slots are defined in a polar array about a center axis of the at least two air-relief plates, and
a ring, wherein the plurality of teeth and the plurality of winding slots extend radially inwards from the ring, wherein the at least two air-relief plates are an annulus shape with an inner diameter and an outer diameter, wherein the inner diameter is defined by the plurality of teeth and the plurality of winding slots, wherein the outer diameter is defined by the ring;
wherein the ring defines a plurality of air-relief slots and a plurality of joints in a plurality of linear arrays extending radially between respective of the plurality of winding slots and the outer diameter;
wherein the plurality of air-relief slots are configured to define a plurality of air-relief passages with the at least two air-relief plates, wherein each of the plurality of winding slots are fluidically coupled with a respective of the plurality of air-relief passages, wherein the plurality of air-relief passages are radially defined between the plurality of winding slots and the outer diameter;
a plurality of slot insulation; and
a plurality of windings, wherein the plurality of slot insulation and the plurality of windings are disposed in the plurality of winding slots, wherein the plurality of slot insulation electrically insulates the stator core from the plurality of windings.

19. The stator of claim 18, wherein the plurality of slot insulation fills at least a portion of the plurality of air-relief passages.

20. The stator of claim 19, wherein the plurality of slot insulation are radially injected into the plurality of winding slots, wherein the plurality of air-relief passages evacuate air when the plurality of slot insulation are radially injected.
